(19) United States
(12) Patent Application Publication
(10) Pub. No.: US 2005/0164831 A1
(43) Pub. Date: Jul. 28, 2005

(54) Power distribution transmission

(76) Inventor: Jurgen Wafzig, Eriskirch (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/031,888

(22) Filed: Jan. 7, 2005

(30) Foreign Application Priority Data
Jan. 28, 2004 (DE) 10 2004 004 138.5

(51) Int. Cl. F16H 37/08

(52) U.S. Cl. 477/198

(57) ABSTRACT

A distributed multi-range transmission is proposed which has one variator (1) designed as toroidal or friction gear variator, as band or chain variator, as cone ring transmission, or as continuously variable hydrostatic transmission, one planetary gear set (3) which engaged in power flow direction before the variator (1) serves as distributor transmission and engaged in power flow direction behind the variator serves as summarizing transmission for the power branches comprising shifting elements (K1, K2) which separately engaged, respectively engage the lower or the upper speed range, the power of the variator being conveyed to the output via a variator output transmission (2) or a shaft (6) situated paraxially with the variator and one direct or overdrive gear is provided in which no power flows via the variator and in direct gear or overdrive operation uncouples the variator from the power flow.

According to the preamble of claim 1, this invention relates to a power distributed transmission comprising one variator.

Transmissions of this kind comprise continuously variable friction gear variators having at least two torus discs with toroidal races between which rolling bodies roll off. Friction gear variators have, together with the continuously variable ratio, a high torque capacity.

DE 196 29 213 A1 has disclosed a transmission which can be operated in two power ranges. The essential component parts of this known friction gear transmission are a continuously variable friction gear variator having two toroidal races interacting in pairs, one countershaft and one summarizing transmission. A power distribution is provided in the lower range (LOW). The input power is conveyed by the input shaft via a reduction step to the countershaft and then to the continuously variable transmission (friction gear variator) which is connected with the summarizing transmission on the output side. Via a second power branch the input power is conveyed via the countershaft and a reduction step directly to the summarizing transmission where the power of both power branches is added up and relayed to the output shaft.

In the second power range (HIGH) of this known transmission, the input power is conveyed via a reduction step to the countershaft and then to the continuously variable transmission. Another power portion is not provided in this case.

The Applicant's DE 197 03 544 A1 has disclosed another transmission where a power distribution is provided and a continuously variable transmission, especially a transmission with toroidal races (friction gear transmission) interacting in pair, is used. This known transmission also has an intermediate shaft or countershaft to make the desired power distribution possible.

In order to improve the efficiency degree of such a transmission in the overdrive, one gear can be provided in which no power flows via the variator. This can be a direct gear; but it is also possible to achieve one other ratio which corresponds to the ratio of the variator or implements another ratio step by way of planetary gear sets or spur gear stages or belt drives or sprocket wheel drives.

From EP 1 253 350 A2 a power distributed two-range transmission of the above mentioned kind has become known in which, to increase the total degree of efficiency in the overdrive, a gear is engaged in which no power flows via the variator since the variator, as a rule, has a poorer degree of efficiency than form-locking force or torque transmitting devices. The transmission comprises one reversing toroidal variator, one summarizing transmission containing a planetary gear set and one planetary gear set serving as reversal transmission, which are consecutively disposed in this sequence in power flow direction.

To engage the overdrive gear, an additional shifting element can be provided; in two-range transmissions, the overdrive gear can be engaged by closing of the range-shifting elements.

The disadvantage results that in a multi-range transmission, where the overdrive gear is engaged by closing of the range shifting elements; stresses are produced in the transmission in case of the smallest divergences of ratio in the variator in the overdrive operation, since in the circuit closed by the two clutches, rotational speed differences generate. These stresses can lead to power losses, to overheating and also to destruction of the transmission.

The problem on which this invention is based is to outline a power distributed transmission having one overdrive gear which overcomes the above mentioned disadvantages of the prior art. Om [articular, no stresses should occur in the overdrive operation.

This problem is solved by the features of claim 1. Other developments and advantages result from the sub-claims.

A power-distributed multi-range transmission is proposed having one variator which can be designed as toroidal or friction gear variator, as band or chain variator, as cone ring transmission or as continuously variable hydrostatic transmission and having one planetary gear set which, when engaged in power flow direction before the variator serves as distribution transmission and when engaged in power flow direction behind the variator serves as summarizing transmission for the power branches comprising shifting elements (range shifting elements) which, individually engaged, respectively change the lower and the upper drive ranges; the power of the variator being conveyed to the output via a variator output transmission or a shaft disposed paraxially with the variator, and there being provided a direct or overdrive gear in which no power flows via the variator and in which the variator is uncoupled from the power flow in the direct gear or overdrive operation.

With the inventive idea stresses are easily prevented in the transmission during the overdrive operation.

According to the invention, in the power flow of the variator, a device is provided which uncouples the variator on the input or output side. The device can be a shifting element, such as a clutch, a synchronizer unit, etc.

According to an advantageous development of the invention, one free wheel is provided as an uncoupling device. It is situated on a place of the transmission which has the same direction of rotation in all driving ranges, the same as in the reverse gear, so as to ensure a reliable uncoupling of the variator. The free wheel is preferably situated in a place in the transmission which, in relation to the power flow direction, is before the devices or parts of the transmission which can produce a reversal of direction of rotation. By using a free wheel as uncoupling device, the cost and installation space requirements are advantageously reduced.

The variator can be designed as toroidal or friction gear variator (single or double cavity, that is, with one or with two toroidal disc pairs), as band or chain gear variator or also as continuously variable hydrostatic transmission.

The invention is described herebelow in detail by way of example with reference to the enclosed figures which show:

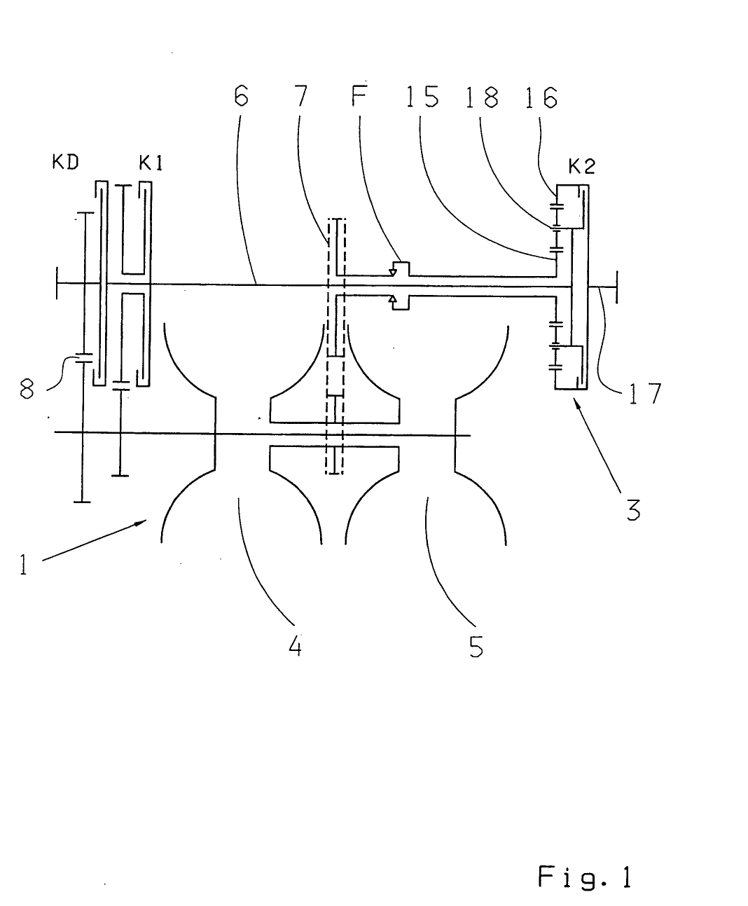

FIG. 1 is a diagrammatic graph of a first preferred embodiment of an inventive transmission;

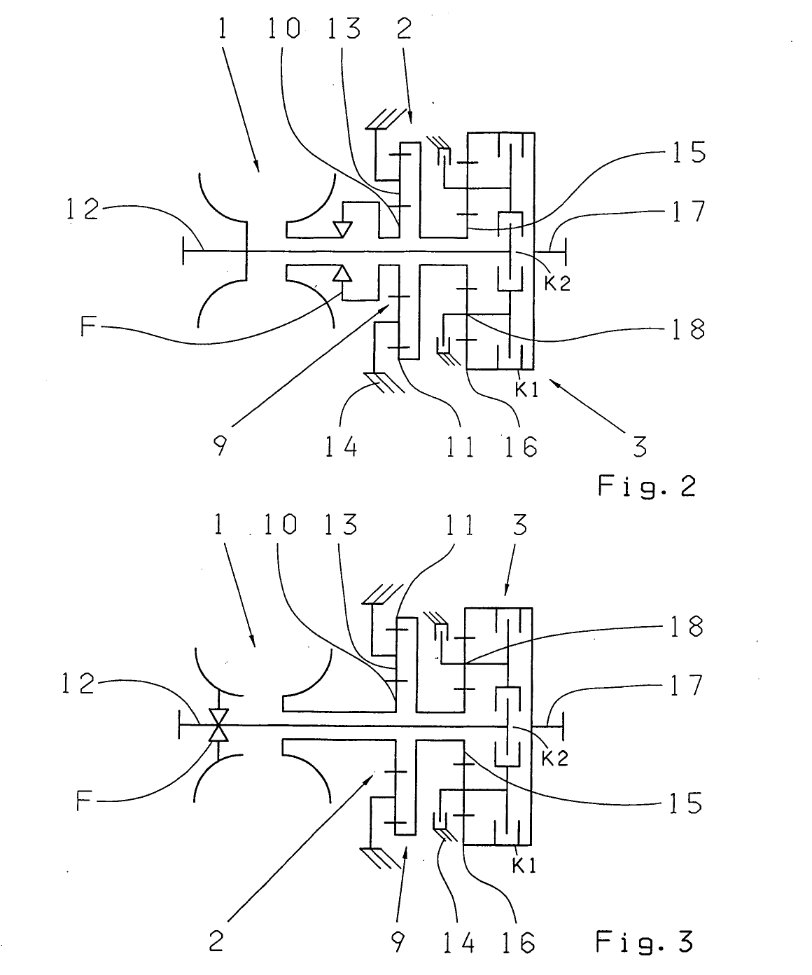

FIG. 2 is a diagrammatic graph of a second preferred embodiment of an inventive transmission;

FIG. 3 is a diagrammatic graph of another preferred embodiment of an inventive transmission;

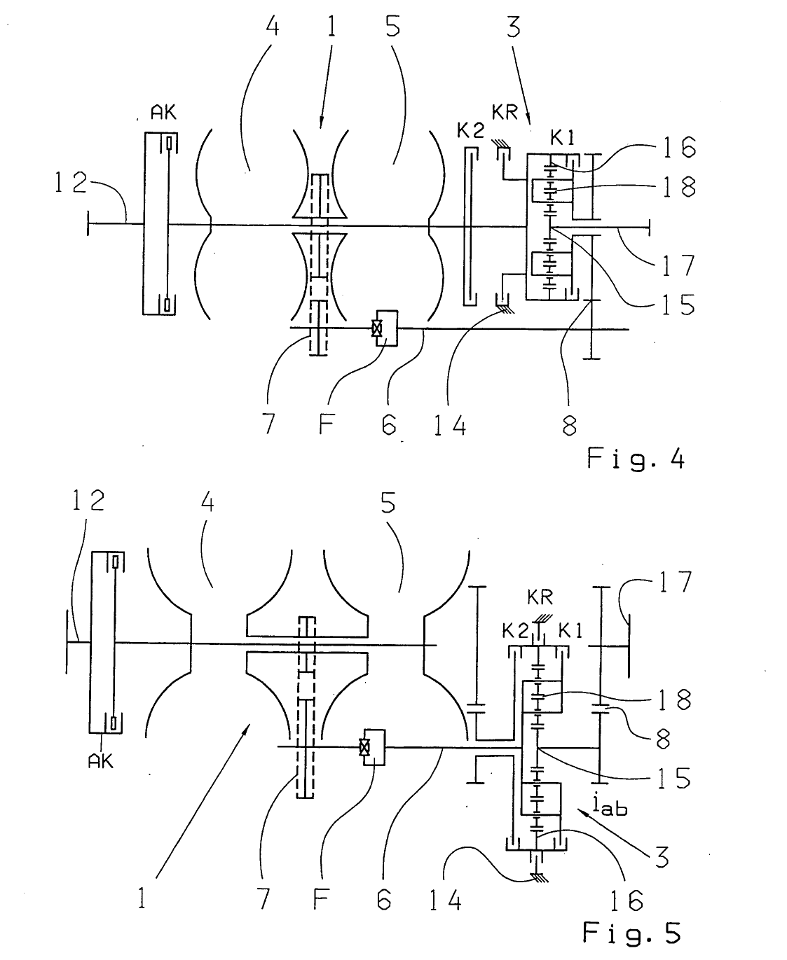

FIG. 4 is a diagrammatic graph of a fourth preferred embodiment of an inventive transmission;

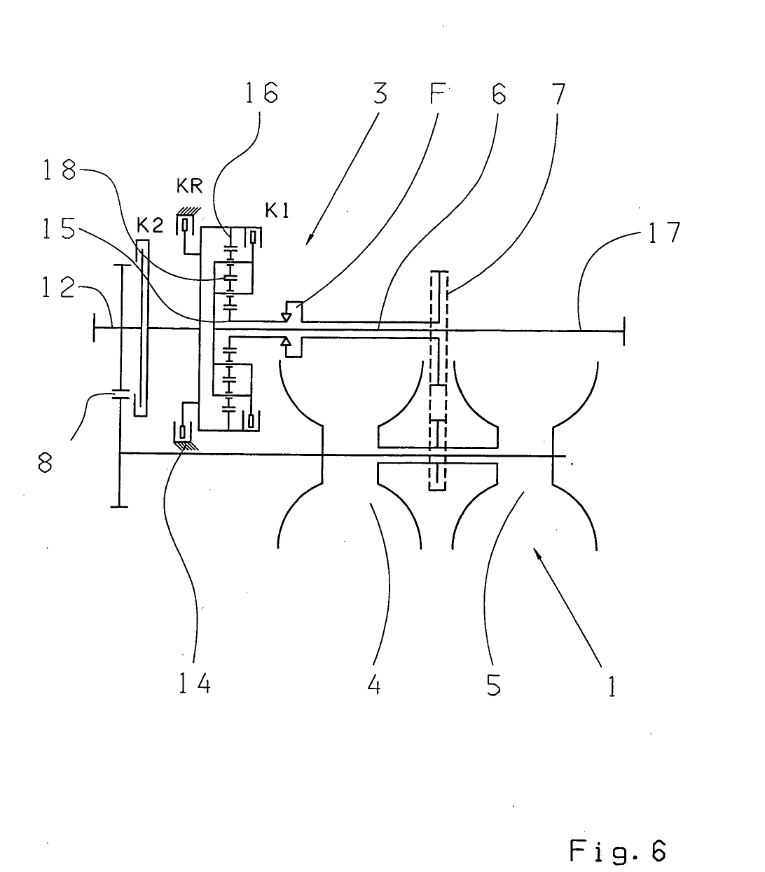

FIG. 5 is a diagrammatic graph of a fifth preferred embodiment of an inventive transmission;

FIG. 6 is a diagrammatic graph of a sixth preferred embodiment of an inventive transmission;

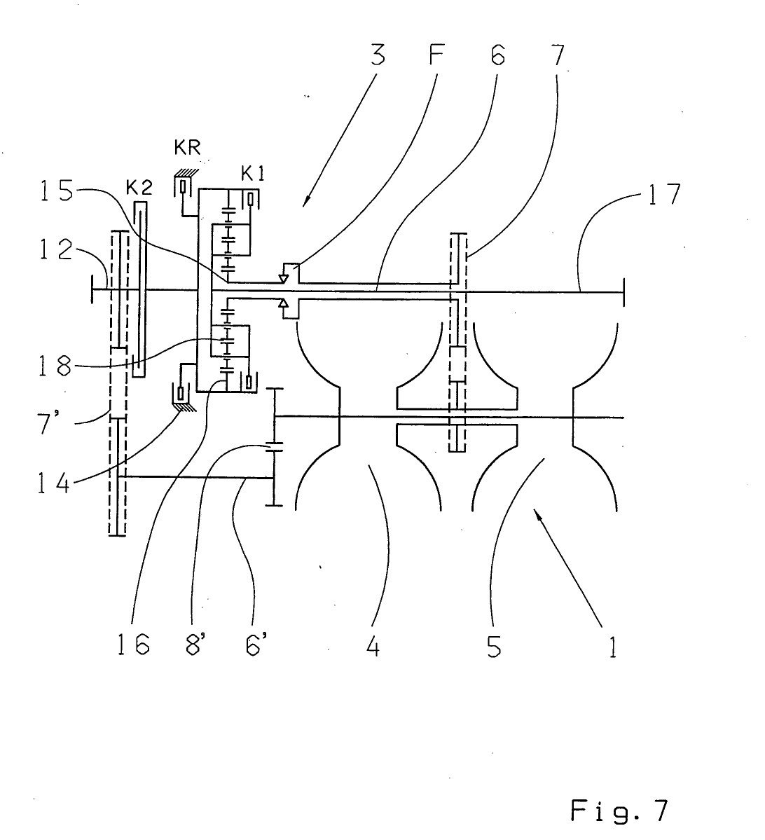

FIG. 7 is a diagrammatic graph of a seventh preferred embodiment of an inventive transmission;

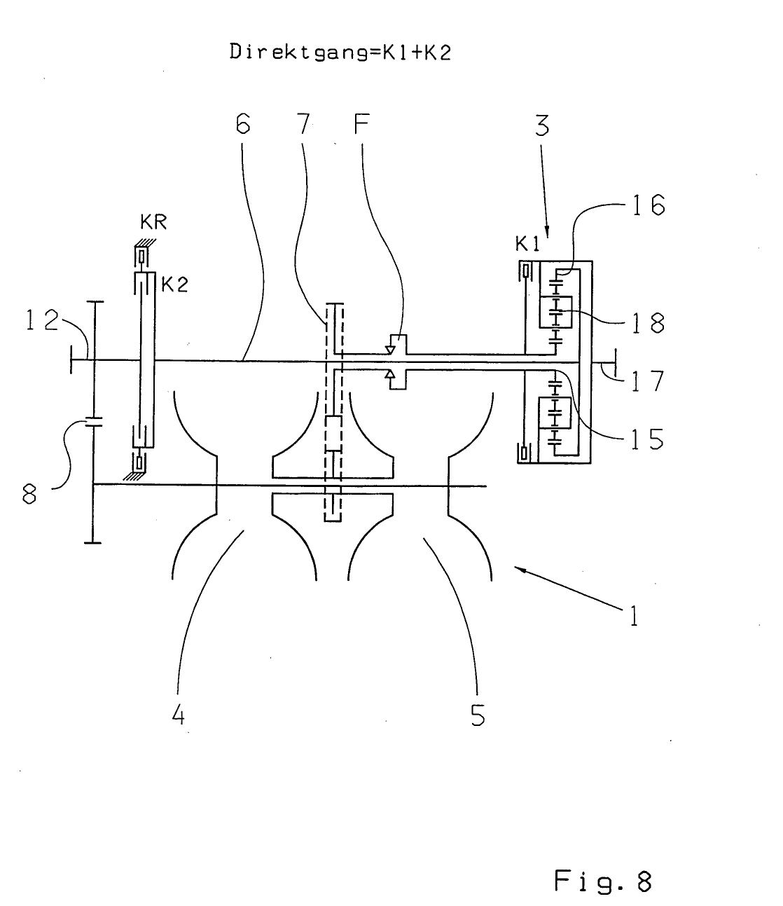

FIG. 8 is a diagrammatic graph of one other preferred embodiment of an inventive transmission;

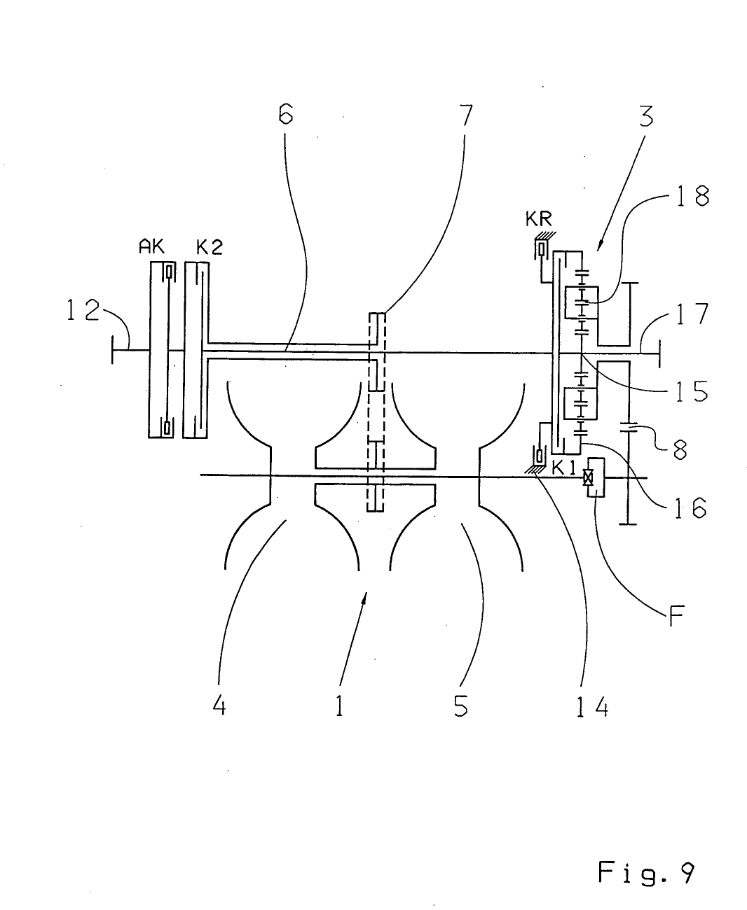

FIG. 9 is a diagrammatic graph of a ninth preferred embodiment of an inventive transmission;

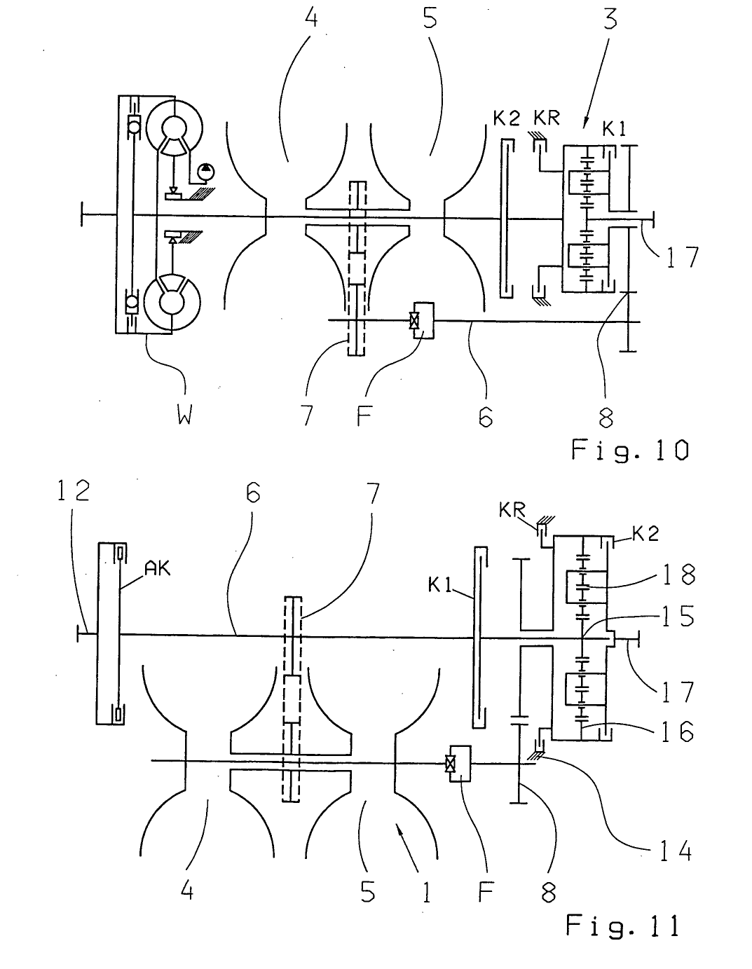

FIG. 10 is a diagrammatic graph of another preferred embodiment of an inventive transmission; and

FIG. 11 is a diagrammatic graph of an eleventh preferred embodiment of an inventive transmission.

The transmission shown in FIG. 1 in geared neutral design comprises one reversing friction gear variator 1, one planetary gear set 3 serving as a summarizing transmission and one shaft 6 disposed paraxially with the variator 1 and through which, by way of a belt drive or sprocket wheel drive 7 between variator discs 4, 5 and a spur gear stage 8, the variator can be driven or the power variator discs 4, 5 and a spur gear stage 8, the variator can be driven or the power of the variator 1 passed to the output of the transmission. The transmission is designed as a reversing transmission with power distribution in the lower speed range; the lower speed range results by closing of a clutch K1 and the upper by closing of a clutch K2 (the planetary gear set 3 rotation in the block operation). One clutch KD is also provided which, when the clutch K2 is closed, engages the direct gear. To prevent the above mentioned stresses, a free wheel F is located in power flow of the variator 1 between the belt drive 7 and the planetary gear set 3.

The transmission shown in FIG. 2 comprises a one-way friction gear variator 1, the planetary gear set 3 serving as summarizing transmission and a variator output 2 which comprises one planetary gear set 9 and has one power distribution on the upper speed range.

The transmission is designed as power distributed reversing transmission. A sun gear 10 of the planetary gear set 9 of the variator output transmission 2 is connected on the input side with the variator output and a ring gear 11, on the output side, with a sun gear 15 of the planetary gear set 3. In addition, a web 13 of the planetary gear set 9 is attached to a housing 14. A web 18 of the planetary gear set 3 is attachable via one brake KR to the housing and, on the input side, is connectable via the clutch K2 with an input shaft 12, a ring gear 16 being connected with an output shaft 17. Besides, the ring gear 16 is connectable via the clutch K1 and the clutch K2 with the input shaft 12; the web 18 is also connectable via the clutch K1 with the ring gear 16.

In the first range (LOW), the clutch K1 is closed and the power flows only via the variator 1, the planetary gear set 9 and the planetary gear set 3 which rotates in the block operation. In the second range (HIGH), a power distribution is provided; the clutch K2 is closed so that the power is transmitted, on one side, by the input shaft 12 to the web 18 of the planetary gear set 3 and, on the other side, by the variator 1 via the planetary gear set 9 to the sun gear 15 of the planetary gear set 3. The total power is transmitted via the ring gear 16 to the output shaft 17. To implement the reverse gear, the shifting element KR is closed.

To engage the direct gear or overdrive gear, no additional shifting element is needed; the overdrive gear is engaged by closing of the clutches K1 and K2 so that the planetary gear set rotates in the block operation driven by the input shaft 12. As is to be inferred from the Figure, one free wheel F is located in power flow direction behind the variator output and before the variator output transmission 2 to prevent stresses in the transmission in the overdrive operation.

The object of FIG. 3 is another possible arrangement of the free wheel F in the transmission shown in FIG. 2. The free wheel F is situated on the input side of the variator 1.

FIG. 4 shows one other power distributed two-range transmission with power distribution in the upper range comprising one reversing friction gear variator 1, one countershaft 6 by way of which the power of the variator 1 is conveyed to the output of the transmission by means of a belt or sprocket wheel drive 7 placed between the variator discs 4, 5 and one spur gear stage 8, one planetary gear set 3 and one starting clutch AK. The lower speed range is engaged by closing of the clutch K1 and the upper by closing of the clutch K2; for the reverse gear the brake KR is closed. To engage the overdrive gear, the clutches K1 and K2 are closed, according to the invention, as uncoupling device of the variator 1 in the overdrive operation, one free wheel F is provided which is located upon the shaft 6 after the belt or sprocket wheel drive 7.

In the transmission shown in FIG. 5 which comprises one countershaft 6, three shifting elements K1, K2 and KR and one planetary gear set 3, the free wheel F is also situated upon the shaft 6 after the belt or sprocket wheel drive 7. Differing from the transmission shown in FIG. 4, the planetary gear set 3 is situated upon the shaft 6; the output shaft 17 is disposed coaxially with the variator 1 so as to provide a spur gear stage 8 in order to transmit the power from the planetary gear set 3 to the output shaft 17. The lower speed range is engaged by closing of the clutch K1 and the upper by closing of the clutch K2; for the reverse gear the brake KR is closed. To engage the overdrive gear the clutches K1 and K2 are closed.

In the transmission shown in FIG. 6, the input and the output result via a shaft 6 disposed paraxially with the variator 1 and to which the power of the variator 1 is conveyed by means of a belt or sprocket wheel drive 7 situated between the variator discs 4, 5. The variator 1 is driven via a spur gear stage 8; in addition, one planetary gear set 3 is situated as summarizing transmission upon the shaft 6. The lower speed range is engaged by closing of the clutch K1 and the upper by closing of the clutch K2; for the reverse gear, the brake KR is closed which connects with the housing the ring gear 16 of the planetary gear set 3. To engage the overdrive gear, the clutches K1 and K2 are closed; the inventively provided free wheel F is placed upon the shaft 6 in power flow direction after the belt drive 7.

The transmission shown in FIG. 7 differs from the transmission in FIG. 6 in that the variator 1 is driven by means of a belt or sprocket wheel drive 7′, one other shaft 6′ and one spur gear stage 8′. The free wheel F is also disposed upon the shaft 6 in power flow direction after the belt drive 7.

FIG. 8 shows one other power distributed two-range transmission having power distribution in the upper speed range in which the planetary gear set 3 serving as summarizing transmission is situated upon a shaft 6 disposed paraxially with the variator 1 and the free wheel F is situated in power flow direction behind the variator input (with belt or sprocket wheel drive 7). The variator 1 is driven via one spur gear stage 8. To engage the overdrive gear, the clutches K1 and K2 are closed which individually engaged, respectively engage the lower and the upper speed range; the reverse gear is engaged by closing of the brake KR.

According to FIG. 9 the transmission comprises one shaft 6 disposed paraxially with the variator 1. The variator 1 is connected with the starting clutch AK by means of one belt or sprocket wheel drive 7 located between the variator discs 4, 5. The variator 1 is connected via a spur gear stage 8 on the output side with the planetary gear set 3 situated upon the shaft 6 and serving as summarizing transmission; the free wheel for uncoupling the variator in the overdrive operation is situated in power flow direction behind the variator. To engage the overdrive gear, the clutches K1 and K2 are closed, which separately engaged, respectively engage the lower and upper speed ranges; the reverse gear is engaged by closing of the brake KR. The starting clutch AK is further provided.

In the embodiment shown in FIG. 10, where the shaft 6 disposed paraxially with the variator 1 is provided for connecting on the output side the variator 1 with a planetary gear set 3 which serves as summarizing transmission and is disposed coaxially with the variator 1, the free wheel for uncoupling the variator in the overdrive operation is situated upon the shaft 6, preferably in power flow direction behind the belt and sprocket wheel 7 and, by means of it, the variator power is transmitted to the shaft 6. The same as in the transmission according to FIG. 9, to engage the overdrive gear, the clutches K1 and K2 are closed which, individually engaged, respectively engage the lower or the upper power distributor speed range; the reverse gear is engaged by closing of the brake KR. In FIG. 10 a converter W is shown for the sake of completeness.

In the transmission shown in FIG. 11, the input and the output result via a shaft 6 disposed paraxially with the variator 1, the variator being connected with the shaft 6 on the input side via a belt or sprocket wheel drive 7 and on the output side via a spur gear stage 8. The free wheel F for uncoupling the variator in the overdrive operation is situated between the output of the belt drive 7 and the spur gear stage 8. To engage the overdrive gear, the clutches K1 and K2 are closed which, individually engaged, respectively engage the lower or the upper speed range, the reverse gear being engaged by closing of the brake KR.

Every constructional design, particularly every spatial arrangement of the planetary gear sets and of the shifting elements, the same as of the free wheel or related to each other and, insofar as technically significant, obviously falls under the scope of protection of the claims without influencing the function of the transmission such as stated in the claims even if said design has not been explicitly shown in the figures or in the description.

### Reference Numerals

1 variator 14 housing

2 variator output transmission 15 sun gear

3 planetary gear set 16 ring gear

4 variator disc pair 17 output shaft

5 variator disc pair 18 web

6, 6′ shaft K1 clutch

7, 7′ belt or sprocket wheel drive K2 clutch

8, 8′ spur gear stage KR brake

9 planetary gear set KD clutch

10 sun gear

11 ring gear AK starting clutch

12 input shaft W converter

13 web F free wheel

1. Power distributed multi-range transmission having one variator (1) designed as toroidal or friction gear variator, as band or chain variator, as cone ring transmission or as continuously variable hydrostatic transmission having one planetary gear set (3) which engaged in flow direction before the variator (1) serves as distributing transmission and engaged in flow direction behind the variator serves as summarizing transmission for the power branches comprising shifting elements (range-shifting elements) (K1, K2) each of which, individually engaged, respectively engages the lower and the upper speed ranges, the power of the variator being conveyed to the output via one variator output transmission (2) or one shaft (6) disposed paraxially with the variator and wherein a direct or overdrive gear is provided in which no power flows via the variator, characterized in that in direct gear or overdrive operation the variator is uncoupled from the power flow.

2. Power distributed multi-range transmission according to claim 1, characterized in that to uncoupled the variator (1), one shifting element is provided which is situated on the input or output side in the power flow of the variator (1).

3. Power distributed multi-range transmission according to claim 2, characterized in that the shifting element is one clutch or one synchronizer unit.

4. Power distributed multi-range transmission according to claim 1, characterized in that to uncouple the variator (1), one free wheel (F) is provided which in power flow of the variator (1) is situated on a place of the transmission which has the same direction of rotation in all speed ranges, the same as in the reverse gear.

5. Power distributed multi-range transmission according to claim 4, characterized in that the free wheel (F) is situated on a place in the transmission which in relation to the power flow direction is located before the devices or component parts of the transmission and can produce a reversal of direction of rotation.

6. Power distributed multi-range transmission according to any one of the preceding claims, characterized in that the direct or overdrive gear is engaged by engaging the (range-shifting elements)(K1, K2).
